(19) United States
(12) Patent Application Publication
(10) Pub. No.: US 2009/0085895 A1
(43) Pub. Date: Apr. 2, 2009

(54) Image generating system having primary and auxiliary display

(75) Inventors: Gregory B. Memo, Irvine, CA (US); William W. Diehl, Irvine, CA (US)

Correspondence Address: GATEWAY, INC.;ATTN: Patent Attorney, 610 GATEWAY DRIVE, MAIL DROP Y-04, N. SIOUX CITY, SD, 57049, US

(73) Assignee: Gateway Inc.

(21) Appl. No.: 11/906,037

(22) Filed: Sep. 28, 2007

(51) Int. Cl. G09G 5/00; G09G 5/08

(52) U.S. Cl. 345/204; 345/1.3

(57) ABSTRACT

An image generating system with a primary display and an auxiliary display, the system comprising a display, the display comprising a primary display area and an auxiliary display area disposed at least partially inside a boundary of the primary display area, the primary display area being in an on condition during a first operational mode of the system and the auxiliary display area being in an on condition during a second operational mode of the system.

### BACKGROUND AND SUMMARY

The present invention relates generally to image generating systems and, more particularly, to image generating systems having primary and auxiliary displays.

It is often desirable for users of image generating systems such as computers to be able to turn off their displays when the computers are not in use. This may be done to conserve power, to prevent others from viewing what is on the display, or for other reasons. Nonetheless, it is often desirable to be able to view certain information, such as critical system information, e.g., battery power available, or communications information, e.g., e-mail received, or other information such as calendar events, reminders, and the like. In certain new notebook computers, auxiliary displays are provided in the case lid of the computer so that, when the computer is closed, auxiliary display information will still be visible without the computer having to be in a fully operative state. While this auxiliary display information may be useful, and it is generally desirable to minimize power consumption when a computer is not in use, it can be inconvenient and, in some circumstances, undesirable to permit others to view even auxiliary information. It is desirable to provide a system that permits display of auxiliary display information without requiring a separate display.

According to an aspect of the present invention, an image generating system with a primary display and an auxiliary display is provided. The system comprises a display, the display comprising a primary display area and an auxiliary display area disposed at least partially inside a boundary of the primary display area. The primary display area is in an on condition during a first operational mode of the system and the auxiliary display area is in an on condition during a second operational mode of the system.

According to another aspect of the present invention, a method for an image generating system comprising a display is provided, the display comprising a primary display area and an auxiliary display area disposed at least partially inside a boundary of the primary display area. According to the method, primary display data is displayed in the primary display area, whether user input has occurred within a predetermined time is determined, and display of auxiliary display data in the auxiliary display area is initiated if no user input has occurred within the predetermined time.

According to another aspect of the present invention, a method for an image generating system comprising a display is provided, the display comprising a primary display area and an auxiliary display area disposed at least partially inside a boundary of the primary display area. According to the method, primary display data is displayed in the primary display area and auxiliary display data is displayed in the auxiliary display area. A cursor is located over a user input area. Whether the user input area is located on the auxiliary display area is determined. When the user input area is not located on the auxiliary display area, user data is inputted in the user input area in the primary display area.

### BRIEF DESCRIPTION OF THE DRAWINGS

The features and advantages of the present invention are well understood by reading the following detailed description in conjunction with the drawings in which like numerals indicate similar elements and in which:

FIGS. 1A-1E are perspective views of systems according to embodiments of the present invention;

FIG. 2 is a perspective view of a system according to an embodiment of the present invention;

FIG. 3 is a schematic view of a prior art display including windows images;

FIG. 4 is a schematic view of a prior art system including multiple, discrete displays;

FIG. 5 is a schematic view of a system according to an embodiment of the present invention;

FIG. 6 is a flow chart showing steps in a method aspect of the present invention; and

FIG. 7 is a flow chart showing steps in another method aspect of the present invention.

### DETAILED DESCRIPTION

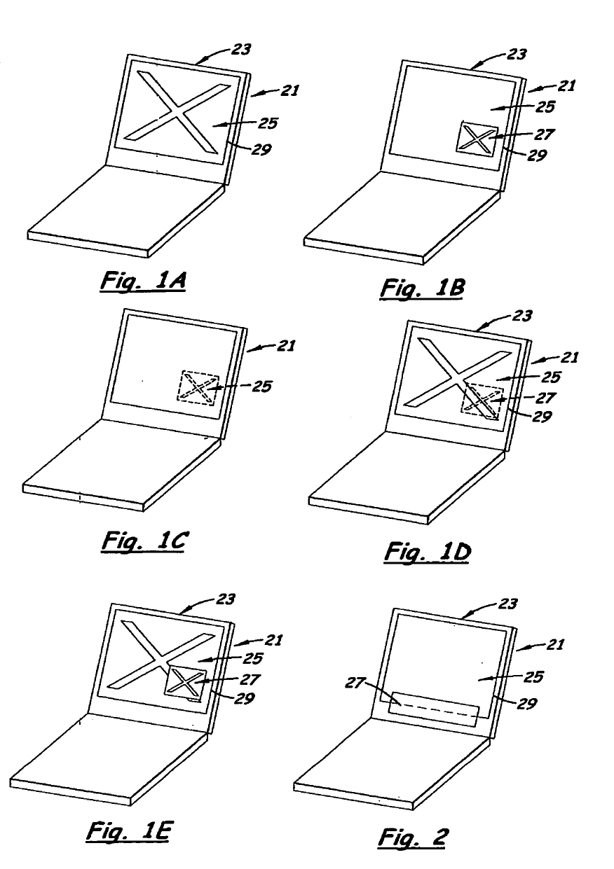

An image generating system 21 with a primary display and an auxiliary display according to an embodiment of the present invention is shown schematically in FIGS. 1A-1E. The system 21 can be any type of system, such as a desktop computer, a laptop computer, a tablet PC, a slate PC, or a handheld device, and includes systems such as television systems. An embodiment in which the system 21 is a laptop computer is shown in FIGS. 1A-1E.

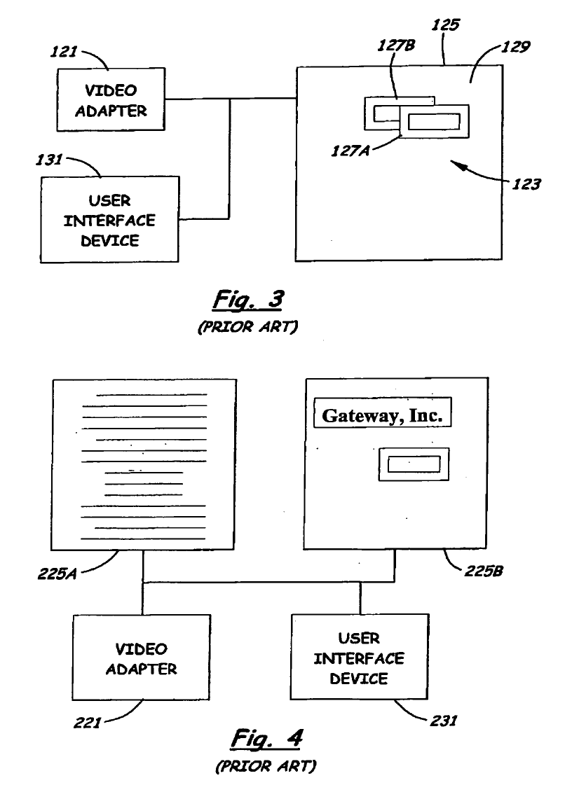

The system 21 comprises a monitor or display 23. The display 23 comprises a primary display area 25 and an auxiliary display area 27 disposed at least partially inside a boundary 29 of the primary display area and, ordinarily, as shown in FIGS. 1B-1E, disposed entirely inside the boundary of the primary display area. FIG. 2 shows an embodiment in which the auxiliary display area 27 is disposed partially, and not entirely, inside the primary display area 25. Instead of two display areas, i.e., a primary display area and an auxiliary display area, the present invention contemplates as many display areas on a display as might be desired.

The primary display area 25 can be “on” during certain operational modes of the system 21, e.g., as shown in FIGS. 1A, 1D, and 1E, and the auxiliary display area 27 can be “on” during other operational modes of the system, e.g., as shown in FIGS. 1B-1E. According to an aspect of the present invention, as seen in FIG. 1A, the auxiliary display area 27 is “off” during an operational mode of the system 21 when the primary display area 25 is “on”.

According to an aspect of the present invention, as seen in FIG. 1B, the primary display area 25 is “off” during an operational mode of the system 21 when the auxiliary display area is “on”. This mode of operation is presently believed to have particular application in systems such as laptop computers in which, when the computer is not in use, it may be desirable to turn off the primary display area 25, but it may still be desirable to display certain information, such as a reduced-size image of the information displayed on the primary display, or personal information manager (PIM) information, such as power status, programs running, who an e-mail message is from, calendar events, reminders, and the like. In this way, the computer can stay on and certain critical information can be viewed on the auxiliary display area 27 without operating the entire primary display area 25, which can minimize the drain of power from the laptop computer's battery. Also, maintaining privacy can be facilitated by displaying only limited information in the auxiliary display area 27 instead of permitting the entire primary display area to be viewed. According to yet another aspect of the present invention, such as is seen in FIG. 1C, information displayed in the auxiliary display area 27 can be displayed at a different intensity than during another operational mode of the system, such as that shown in FIG. 1B, such as at an intensity that drains less battery power.

According to yet another aspect of the present invention, as seen in FIGS. 1D and 1E, the primary display area 25 and the auxiliary display area 27 are “on” simultaneously during an operational mode of the system. It will be appreciated that a system 21 can be arranged to permit operation in any of the operational modes described herein, and that the ability to operate in one mode of operation or another is not necessarily mutually exclusive of the ability to operate in another mode of operation.

According to another aspect of the present invention, during an operational mode of the system 21 shown in FIG. 1D, information displayed in the auxiliary display area 27 can be displayed at a different intensity than during another operational mode of the system, such as the operational mode shown in FIG. 1B. For example, information displayed in the auxiliary display area 27 may be displayed at a lesser intensity than during another operational mode in which information is displayed in the auxiliary display area so that the information displayed in the primary display area 25 is visible behind the information displayed in the auxiliary display area, i.e., the information displayed in the auxiliary display area is translucent. The information on the primary display area 25 “behind” the auxiliary display area 27 can be displayed at a different intensity than the rest of the information on the primary display area, i.e., usually at a lower intensity. Alternatively, the information displayed in the primary display area 25 overlapping with the auxiliary display area 27 can be translucent, i.e., the auxiliary display area can be considered to be “behind” the primary display area.

According to another aspect of the present invention, during an operational mode of the system 21 shown in FIG. 1D, information displayed in the auxiliary display area 27 can be opaque and the information in the primary display area 25 overlapping the auxiliary display area is not visible.

In the sense used in the present application, a “display area” is distinct from, e.g., a window. In the present application, each display area may include one or more windows, however, each display area is not merely a window in the conventional sense. In windowing systems, typically, as seen in FIG. 3, a single video or graphics adapter, herein referred to as a video adapter 121, corresponds to the image 123 displayed on a display 125 and, when one or more windows 127a, 127b appear and occupy a limited area of the overall display area 129, only one of those windows 127a is active at a time: for example, user input from a user interface 131 such as a keyboard or mouse to only the active window 127a is possible. The video adapter 121 understands that it is writing to a single piece of hardware, i.e., a single display 125.

Where multiple displays have been used in the past, typically, as seen in FIG. 4, each display 225a and 225b is a separate component connected to one or more video adapters 221. The multiple displays 225a and 225b may be used to, e.g., display a single large spreadsheet for a single application on both displays into either of which a user can input information from a user interface 231 depending upon, for example, the location of a cursor. Another possible arrangement in the system shown in FIG. 4 might involve, e.g., simultaneous displays of different applications, e.g., a word processing application in display 225a and an internet browser application in display 225b, into either of which a user can input information from the user interface 231 depending upon, e.g., the position of a cursor. Additionally, information entered on one display 225a may be reflected on the other display 225b, such as when changes to a web page's code is made on one display and the results are viewed on the other. However, each one of the displays 225a and 225b corresponds to a single display area and the video adapter(s) understand that, for each display, it is writing to a single piece of hardware.

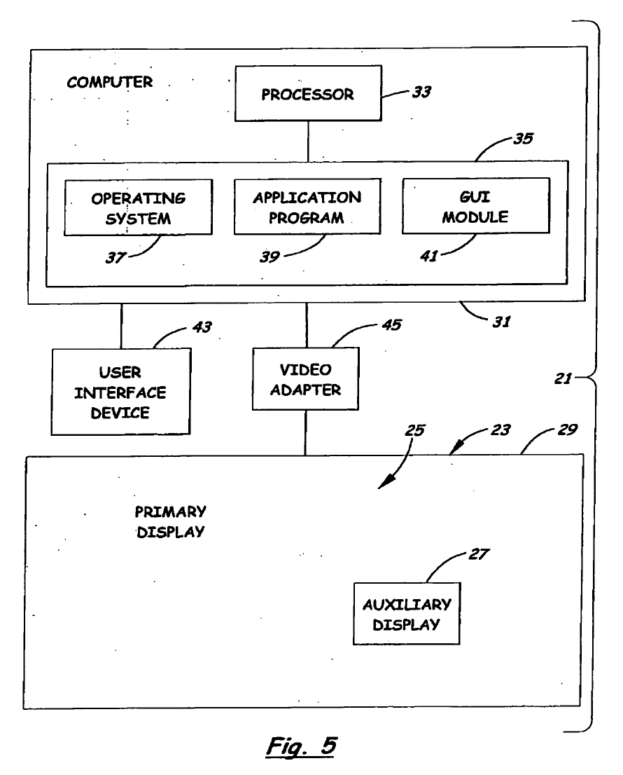

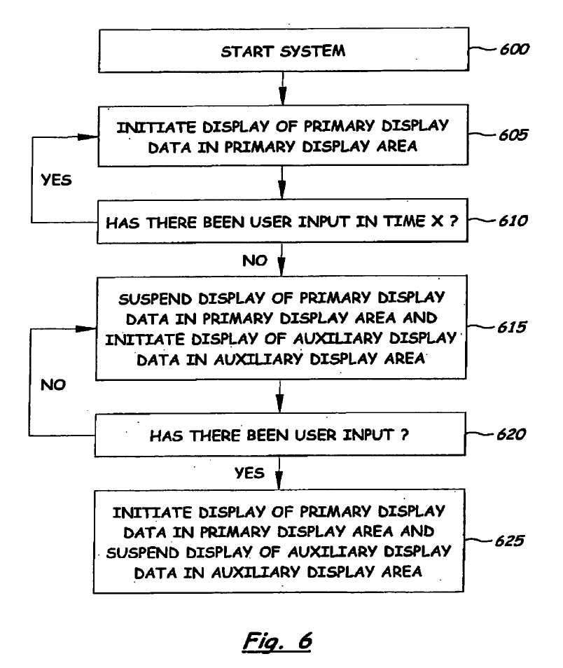

The system 21 according to the various aspects of the present invention can operate in one or more of myriad ways. According to an aspect of the invention shown in FIG. 5, the system 21 comprises a computer 31 is configured to control two display areas, at least one of the display areas at least partially disposed inside of a boundary of the other. The computer 31 typically comprises a processor 33 and a memory 35 for storing information and instructions for the processor. The memory 35 typically comprises an operating system 37 and an application program 39. A graphical user interface module (GUI) 41 is typically provided to permit the computer 31 to interface with a user through user interface devices 43 such as keyboards, mice, and the like. The GUI 41 may be implemented in various ways, such with special purpose components or as part of the operating system 37 or the application program 39. It will be appreciated that the system 21 according to the present invention can be implemented through a variety of embodiments not necessarily limited to the embodiments described here for purposes of illustration.

A video adapter 45 is typically provided between the display 23, the computer 31, and the user interface devices 43 to permit display data to be sent to the display. It will be appreciated that the display 23 and the video adapter 45 may be considered to be part of the computer 31, however, for purposes of discussion, they shall be referred to here as separate components. The video adapter 45 may include a processor and/or memory capable of implementing the system 21 according to the present invention, or the system can be implemented through the processor and/or memory in the computer 31, or the system can be implemented through the processor and/or memory in both the computer and the video adapter.

According to an aspect of the present invention, the auxiliary display area 27 can be virtualized in the primary display area 25. According to an aspect of the present invention, the virtualized auxiliary display can be virtualized by hardware such as the processor 33 independent of the operating system 37 and that can present the operating system with a representation of, e.g., the primary display area 25 in an active or “on” condition (or other desired information) that is smaller than the actual primary display area. The remaining area of the display 23, i.e., the portion of the primary display area 25 outside of the auxiliary display area 27 can have other display data redirected to it, such as a blank screen, a screen saver, or other display data.

The virtualization of the auxiliary display area 27 can also be done in software, e.g., by the application program 39. The software can present the information for the auxiliary display area 27 to the operating system 37 as a window in the primary display area 25. Moreover, the software, e.g., the application program 39, can present the operating system 37 with display data for the auxiliary display area 27 and can composite the auxiliary display area over the primary display area 25, such as in the form of a semi-transparent or translucent layer.

A software patch (which may be, for example, part the application program 39 of the memory 35) can present the system 21 with views of different displays, i.e., a primary display area and an auxiliary display area, corresponding to different display data available to the system. The software can then transmit the display information in different ways, such as by transmitting the auxiliary display data in the form of a window in the operating system, a translucent layer over the primary display, or a subsection of the entire display 23 that is cordoned off from the part that the operating system uses for the primary display.

The computer 31 and/or the video adapter 45 can be configured to treat the first display area 25 and the second display area 27 as separate pieces of hardware. The computer 31 and/or the video adapter 45 may be configured, e.g., through an appropriate software patch, so that primary or auxiliary display data is transmitted only when auxiliary and primary display data, respectively, is not transmitted. For example, as seen in the flow chart shown in FIG. 6, when the system 21 is started up at step 600, the computer 31 and video adapter 45 transmit display data for the primary display area 25 at step 605. When, at step 610, the computer 31 detects no user inputs for a period of time X, transmission of primary display data may be suspended and transmission of auxiliary display data may be initiated at step 615. When, at step 620, user input is detected, auxiliary display data transmission may be suspended and primary display data transmission may be initiated at step 625. Of course, the computer 31 and/or the video adapter 45 may also or in the alternative be configured to simultaneously transmit first and second display data so that images are displayed in the primary display area 25 and in the auxiliary display area 27 at the same time. Ordinarily, it is contemplated that, if an image is displayed in both the primary display area 25 and in the auxiliary display area 27, the image displayed in the auxiliary display area will appear “on top” of an overlapping portion of the image displayed in the primary display area, or that the image displayed in the auxiliary display area will be translucent so that the image displayed in the primary display area is visible beneath the image displayed in the auxiliary display area.

In an aspect of the present invention, the video adapter 45 can function in much the same way as a video adapter that is configured to send display data to two different displays as shown in FIG. 4, except hardware 35 and/or software 37 can be provided to send first display data to the primary display area 25 and second display data to only a limited portion of the display 23, i.e., the auxiliary display area 27. While FIG. 4 shows the primary display area 25 and the auxiliary display area 27 controlled by a video adapter 45 to which the primary and auxiliary display areas are connected to individually, it will be appreciated that data can be transmitted from, e.g., the video adapter to the display 23 including the primary and auxiliary display areas by connecting the display areas in series. Further, data can be transmitted to a display by wireless means.

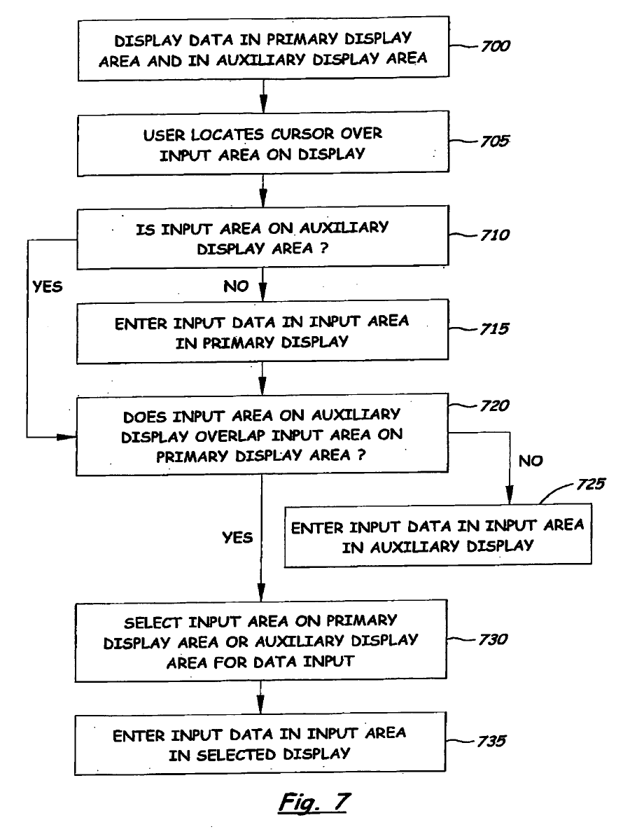

The primary display area 25 and the auxiliary display area 27 can each be adapted to accept input from an input device such as a user interface 43 such as a keyboard or mouse when both display areas are in an “on” condition in substantially the same way that, as in the embodiment shown in FIG. 4, input from a user interface 231 can be inputted into different applications on either of two separate displays 225a or 225b. When display data is displayed in both the primary display area 25 and in the auxiliary display area 27 as shown at step 700 in FIG. 7, user input at step 705 such as the positioning of a cursor at a point on the display 23 can be controlled by the computer 31 and/or the video adapter 45 so that input to the primary display area is only possible in areas that are not overlapped by the auxiliary display area. A determination can be made at step 710 whether the input area is on the auxiliary display area 27 and, if not, input data can be entered in the input area on the primary display area at step 715. If the input area is determined to be on the auxiliary display area 27 at step 710, then a determination can be made at step 720 whether an input area on the primary display area 25 and an input area on the auxiliary display area overlap. If input areas on the primary display area 25 and the auxiliary display area overlap, the user can manually input a selection as to which input area the input data is to be input by providing some suitable control signal to select one or the other of the input areas at step 730 (or the selection can be made automatically by, e.g., the application program 39) and input data can be entered in the selected input area at step 735. If there is no overlap, input data can be entered in the input area on the auxiliary display area 27 at step 725. Such an arrangement may be preferable particularly when the auxiliary display area 27 is opaque in the sense that it completely obscures the overlapped portion of the primary display area 25.

In the present application, the use of terms such as “including” is open-ended and is intended to have the same meaning as terms such as “comprising” and not preclude the presence of other structure, material, or acts. Similarly, though the use of terms such as “can” or “may” is intended to be open-ended and to reflect that structure, material, or acts are not necessary, the failure to use such terms is not intended to reflect that structure, material, or acts are essential. To the extent that structure, material, or acts are presently considered to be essential, they are identified as such.

While this invention has been illustrated and described in accordance with a preferred embodiment, it is recognized that variations and changes may be made therein without departing from the invention as set forth in the claims.

What is claimed is:

1. An image generating system with a primary display and an auxiliary display, the system comprising a display, the display comprising a primary display area and an auxiliary display area disposed at least partially inside a boundary of the primary display area, the primary display area being in an on condition during a first operational mode of the system and the auxiliary display area being in an on condition during a second operational mode of the system.

2. The system as set forth in claim 1, wherein the primary display area is in an off condition during the second operational mode of the system.

3. The system as set forth in claim 2, wherein the auxiliary display area is in an off condition during the first operational mode of the system.

4. The system as set forth in claim 3, wherein the primary display area and the auxiliary display area are in the on condition simultaneously during a third operational mode of the system.

5. The system as set forth in claim 4, wherein, during the third operational mode of the system, the primary display area and the secondary display area are each adapted to accept input from an input device.

6. The system as set forth in claim 4, wherein, during the third operational mode of the system, information displayed in the auxiliary display area is displayed at a different intensity than during the second operational mode of the system.

7. The system as set forth in claim 1, wherein the primary display area and the auxiliary display area are in the on condition simultaneously during the first operational mode of the system.

8. The system as set forth in claim 7, wherein, during the first operational mode of the system, information displayed in the auxiliary display area is displayed at a different intensity than during the second operational mode of the system.

9. The system as set forth in claim 8, wherein, during the first operational mode of the system, the primary display area and the secondary display area are each adapted to accept input from an input device.

10. The system as set forth in claim 1, wherein the auxiliary display area is in an off condition during the first operational mode of the system.

11. The system as set forth in claim 1, wherein the auxiliary display area is disposed entirely inside the boundary of the primary display area.

12. The system as set forth in claim 11, wherein the auxiliary display area is smaller than the primary display area.

13. The system as set forth in claim 1, comprising a software driver arrangement for controlling an on/off condition of the primary display area and the auxiliary display area.

14. The system as set forth in claim 1, comprising a video adapter with a first display connection for controlling the primary display area and a second display connection for controlling the auxiliary display area.

15. The system as set forth in claim 1, wherein the primary display area and the auxiliary display area are each adapted to accept input from an input device when in an on condition.

16. The system as set forth in claim 1, wherein the primary display displays information relating to a first application and the auxiliary display displays information relating to a second application.

17. A method for an image generating system comprising a display, the display comprising a primary display area and an auxiliary display area disposed at least partially inside a boundary of the primary display area, comprising:
displaying primary display data in the primary display area;
determining whether user input has occurred within a predetermined time; and
initiating display of auxiliary display data in the auxiliary display area if no user input has occurred within the predetermined time.

18. The method according to claim 17, comprising suspending display of primary display data in the primary display area if no user input has occurred within the predetermined time.

19. The method according to claim 18, comprising initiating display of primary display data in the primary display area after user input is detected.

20. The method according to claim 18, comprising suspending display of auxiliary display data in the auxiliary display area after user input is detected.

21. A method for an image generating system comprising a display, the display comprising a primary display area and an auxiliary display area disposed at least partially inside a boundary of the primary display area, comprising:
displaying primary display data in the primary display area and auxiliary display data in the auxiliary display area;
locating a cursor over a user input area;
determining whether the user input area is located on the auxiliary display area; and
when the user input area is not located on the auxiliary display area, inputting user data in the user input area in the primary display area.

22. The method according to claim 21, comprising, when the user input area is located on the auxiliary display area, determining whether the user input area overlaps a user input area on the primary display area.

23. The method according to claim 22, comprising, when the user input area does not overlap a user input area on the primary display area, inputting user data in the user input area in the auxiliary display area.

24. The method according to claim 22, comprising, when the user input area does overlap a user input area on the primary display area, selecting one of the user input area on the auxiliary display area and the user input area on the primary display area for inputting of information, and inputting user data in a selected on of the user input area on the auxiliary display area and the user input area on the primary display area.
